(19) United States
(12) Patent Application Publication
(10) Pub. No.: US 2011/0193813 A1
(43) Pub. Date: Aug. 11, 2011

(54) Touchpad Input Device

(75) Inventors: William Adam Gralewski, Houston, TX (US); Kevin L. Massaro, Houston, TX (US); Peter M. On, Houston, TX (US)

(73) Assignee: HEWLETT-PACKARD DEVELOPMENT COMPANY, L.P., Houston, TX (US)

(21) Appl. No.: 13/125,084

(22) PCT Filed: Oct. 22, 2009
(86) PCT No.: PCT/US2009/061621

§ 371 Date: Apr. 20, 2011

Related U.S. Application Data
(63) Continuation-in-part of application No. PCT/US2008/081141, filed on Oct. 24, 2008.

(51) Int. Cl. G06F 3/041; G08C 21/00

(52) U.S. Cl. 345/173; 178/18.03

(57) ABSTRACT

An input device, notebook computer, keyed input device, and a method are provided. A touchpad housing is comprised of a touchpad depression area. The touchpad comprised of a movement input area and a button area is attached to the touchpad housing. The touchpad is configured to detect a presence of an input at a location on the touchpad. A switch is located below the button area of the touchpad. A haptic response component is also provided for generating a haptic response in response to application of a pressure from the input to the button area.

### BACKGROUND

An improved touchpad input device is needed that provides an improved user experience.

### SUMMARY

According to one embodiment, an input device is provided that includes a touchpad housing comprised of a touchpad depression area. A touchpad is attached to the touchpad housing and is comprised of a movement input area, and a button area. The touchpad is configured to detect a presence of an input at a location on the touchpad. A switch is located below the button area of the touchpad. A haptic response component is also provided for generating a haptic response in response to application of a pressure from the input to the button area.

According to another disclosed embodiment, a computer notebook is provided that includes a keyed input housing as well as a keyboard attached to the keyed input housing. A touchpad housing attached to the keyed input housing is comprised of a touchpad depression area. A touchpad attached to the touchpad housing is provided and comprised of a movement input area, and a button area. The touchpad is configured to detect a presence of an input at a location on the touchpad. A switch is located below the button area of the touchpad. A haptic response component is also provided for generating a haptic response in response to application of a pressure from the input to the button area.

According to a further embodiment, a keyed input device having a keyed input housing is provided. A keyboard is attached to the keyed input housing. A touchpad housing comprised of a touchpad depression area is attached to the keyed input housing. A touchpad attached to the touchpad housing is provided and comprised of a movement input area, and a button area. The touchpad is configured to detect a presence of an input at a location on the touchpad. A switch is located below the button area of the touchpad. A haptic response component is also provided for generating a haptic response in response to application of a pressure from the input to the button area.

According to yet another disclosed embodiment, a method of detecting input through a touchpad is provided. The method includes the steps of detecting a presence of an input, detecting a pressure of the input, and generating a haptic response to the pressure.

### BRIEF DESCRIPTION

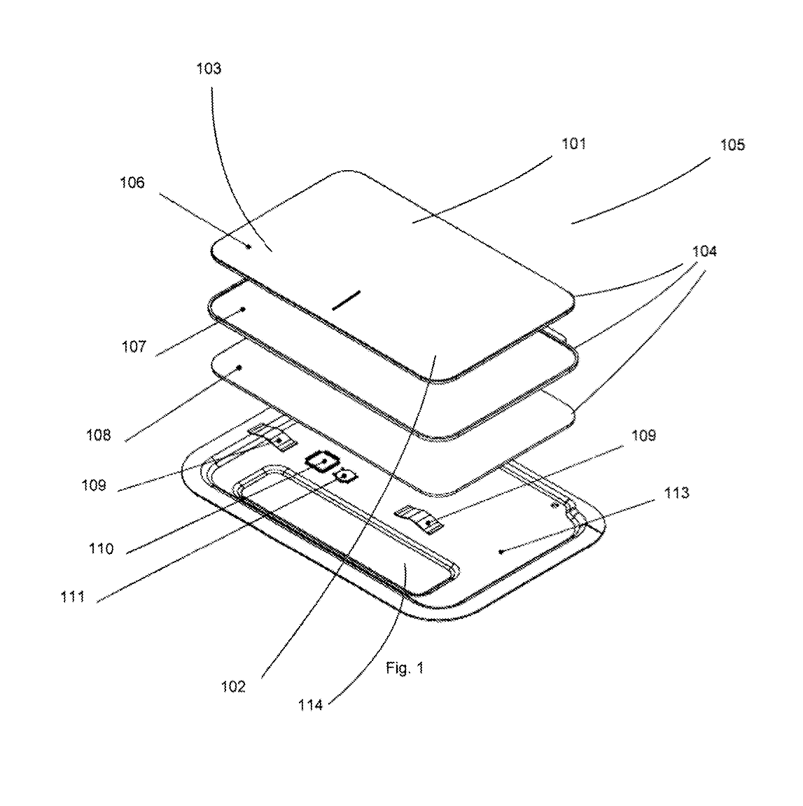

FIG. 1 is an exploded view of an input device, according to one embodiment.

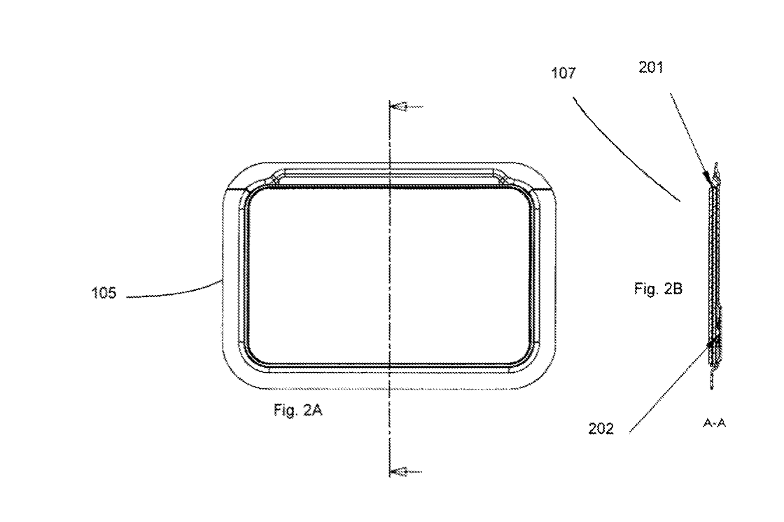

FIG. 2A is a top-down view of an input device, according to one embodiment.

FIG. 2B is a cross-section view of an input device illustrating elements of a pivot support, according to one embodiment.

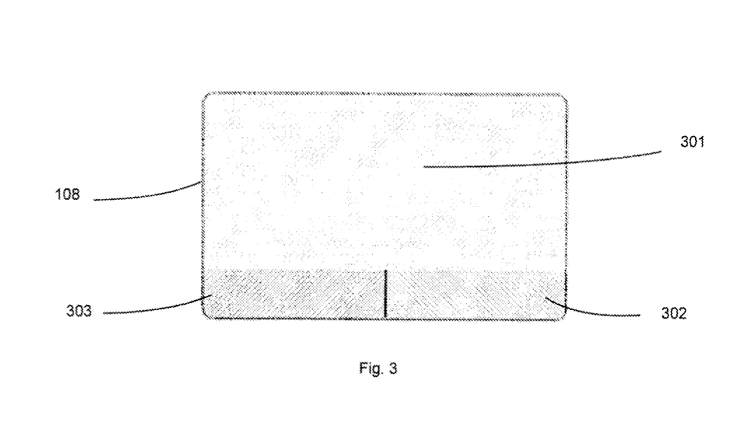

FIG. 3 is a top-down view of an electronic input detection device of an input device, according to one embodiment.

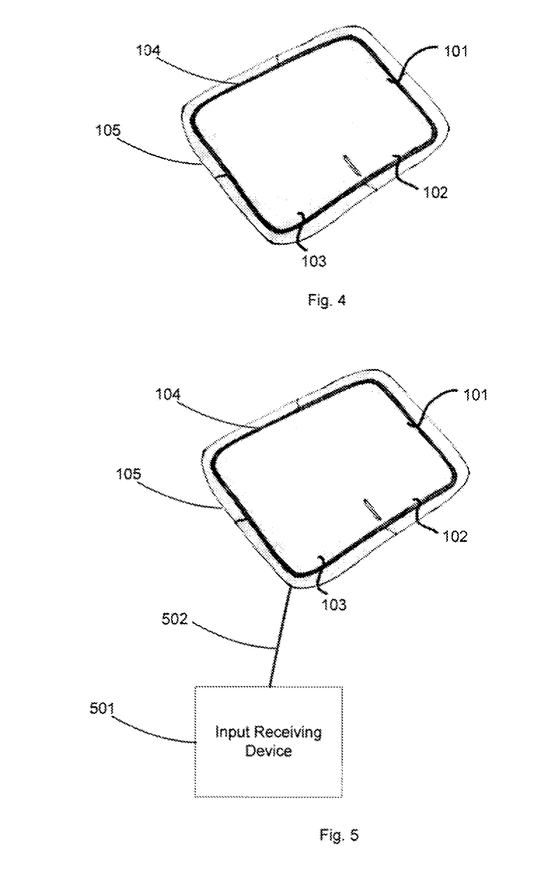

FIG. 4 is an isometric view of an input device, according to one embodiment.

FIG. 5 is a diagram of an input device connected to an input receiving device, according to one embodiment.

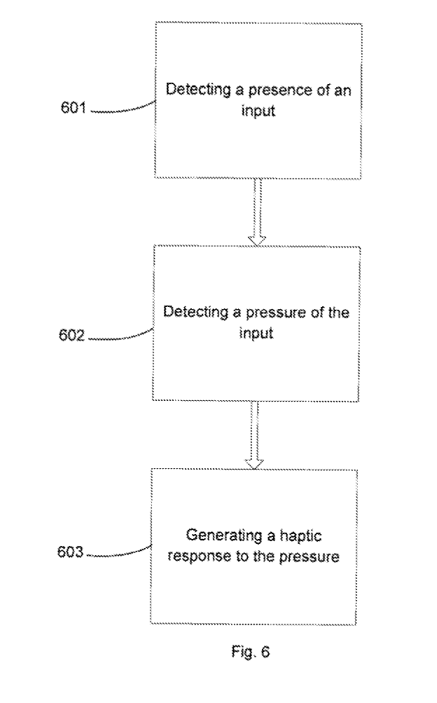

FIG. 6 is a flowchart detailing a method of detecting an input, according to one embodiment.

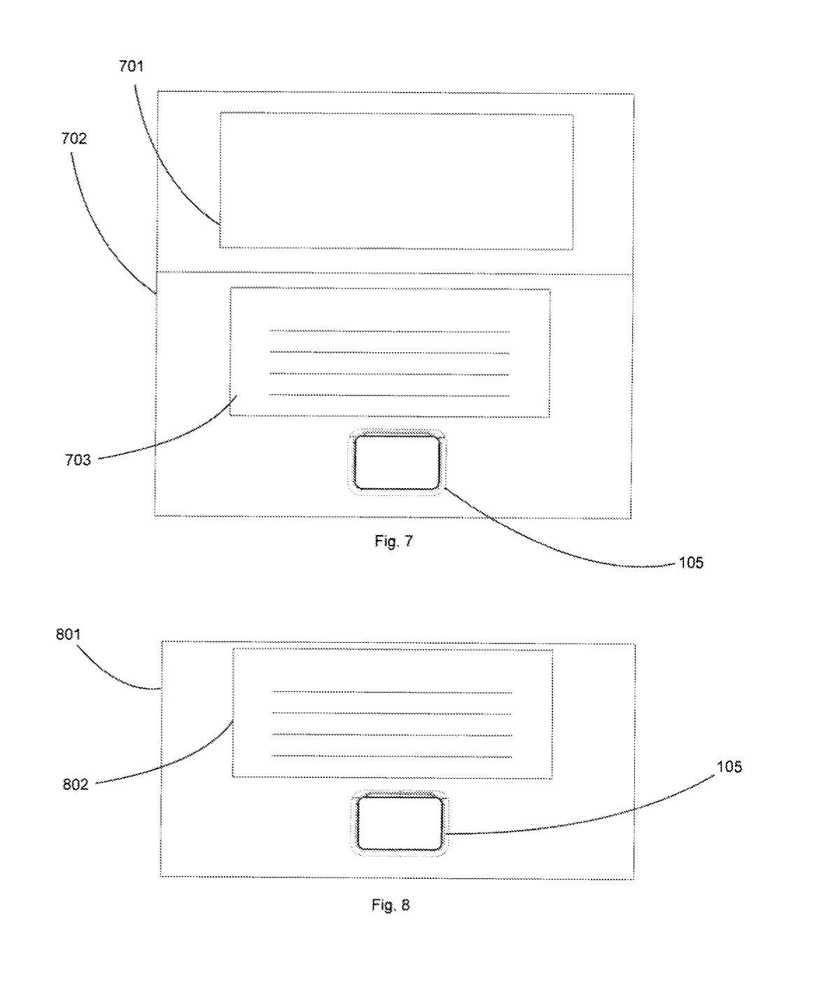

FIG. 7 is a notebook computer including an input device, according to one embodiment.

FIG. 8 is a keyed input device including an input device, according to one embodiment.

### DETAILED DESCRIPTION

Embodiments of the present disclosure will be described below with reference to the accompanying drawings. It should be understood that the following description is intended to describe exemplary embodiments of the invention, and not to limit the invention.

It should be noted that the word “component” as used herein is intended to encompass implementations using one or more lines of software code, and/or hardware implementations, and/or equipment for receiving manual inputs.

Referring now to FIG. 1. FIG. 1 is an exploded view of an input device 105, according to one embodiment. The input device 105 has a touchpad housing 113 configured with a touchpad depression area 114. The input device 105 also has a touchpad 104 attached to the touchpad housing 113 with a movement input area 101, a button area (102 and 103 combined), and a haptic response component (109, 111, 104). A switch 111 is located below the touchpad 104. The touchpad 104 detects the presence of an input at a location on the touchpad 104.

An example of an input detected by the touchpad 104 may be a human finger. Alternatively, the input detected may be a pencil or a pen. The detection of an input may be done in a variety of different ways. In some embodiments, the touchpad 104 is configured to detect optical input. In other embodiments, the touchpad 104 is configured to detect magnetic input. In yet other embodiments, the touchpad 104 is configured to detect capacitance or conductance. The touchpad 104 is configured to detect the movement of an input across the touchpad 104 by detecting the presence of the input at discrete locations over time in either of the movement input area 101 or the button area (102 and 103 combined). The input device 105 is also configured such that the button input area (102 and 103 combined) of the touchpad 104 detects the presence of an input, and the switch 111 detects depression of itself when the input applies pressure to the button area (102 and 103 combined) of the touchpad 104. The depression of the switch 111 and the detection of the input in the button area (102 and 103) in combination indicates a button of the touchpad 104 was intended to be depressed. A haptic response component (109, 111, 104) generates a haptic response in response to the application of the pressure to the button area (102 and 103 combined).

In some embodiments, the button area (102 and 103 combined) is comprised of a left button area 103 and a right button area 102. Accordingly, application of pressure by an input detected within the region of the left button area 103 as opposed to the region of the right button area 102 is indicative of separate desired button input. The detection of where the input pressure is applied determines which of the buttons represented by the left button area 103 and right button area 102 was intended to be depressed. By way of example, a user may place her finger in the left button area 103 and apply pressure depressing the switch 111 under the touchpad 104. Here, the touchpad 104 detects the presence of the finger input in the left button area 103 in combination with the depression of the switch 111, which indicates that the user intended to supply left button input corresponding to the left button area 103. The right button corresponding to the right button area 102 may be similarly activated.

The touchpad housing 113 is configured with a touchpad depression area 114. Upon application of pressure to the button area (102 and 103 combined) of the touchpad 104, the touchpad 104 deforms towards and into the touchpad depression area 114 of the touchpad housing 113. The touchpad depression area 114 provides a void into which the touchpad 104 assembly may deform. The touchpad housing 113 may be comprised of any number of materials. In some embodiments, the touchpad housing 113 is made from plastic. In other embodiments, the touchpad housing 113 is made of metal such as aluminum.

In the illustrated embodiment of FIG. 1, the touchpad 104 of the input device 105 is comprised of a cosmetic cover 106, a pivot support 107, and a touchpad circuit board 108.

The cosmetic cover 106 is provided to shield the touchpad circuit board 108 and the pivot support 107 from the user. Additionally, the cosmetic cover 106 adds aesthetic features to the input device 105. Accordingly, the cosmetic cover 106 may be provided in any number of different colors. Additionally, in some embodiments, it may be preferable to visually indicate the regions corresponding to the movement input area 101, and the button area (102 and 103 combined) on the cosmetic cover 106. In one embodiment the cosmetic cover 106 is colored one color for the area corresponding to the movement input area 101, and the cosmetic cover 106 is colored another color for the area corresponding to the button area (102 and 103 combined). In yet other embodiments, the cosmetic cover 106 is colored one color for the area corresponding to the movement input area 101, the cosmetic cover 106 is colored another color for the area corresponding to a right button area 102, and the cosmetic cover 106 is colored yet another color for the area corresponding to a left button area 103. The regions corresponding to the movement input area 101 and the button area (102 and 103 combined) may also be indicated through light illumination. Accordingly, in some embodiments the cosmetic cover 106 region corresponding to the movement area 101 is configured to illuminate one color, and the cosmetic cover 106 region corresponding to button area (102 and 103 combined) is configured to illuminate another color. In other embodiments, the cosmetic cover 106 region corresponding to the movement area 101 is configured to illuminate one color, the cosmetic cover 106 region corresponding to a right button area 102 is configured to illuminate another color, and the cosmetic cover 106 region corresponding to a left button area 103 is configured to illuminate yet another color. The illumination of the cosmetic cover 106 may be provided with any suitable light source such as LEDs. In some embodiments, the LEDs are a conventional semiconductor diode LED. In other embodiments, the LEDs are quantum dot LEDs composed of semiconductor nanocrystals. In yet other embodiments, the LEDs are organic LEDs.

Referring now to FIGS. 2A and 2B in combination with FIG. 1. FIG. 2A is a top-down view of an input device 105, according to one embodiment. FIG. 2B is a cross-sectional view of an input device 105 illustrating elements of the pivot support 107, according to one embodiment. The pivot support 107 is comprised of a pivot point 201 and a switch contact point 202. The touchpad 104 is attached to the touchpad housing 113 at the pivot point 201 of the pivot support 107. The pivot support 107 is provided such that when an input applies pressure on the cosmetic cover 106 of the touchpad 104, the touchpad 104 assembly deforms about the pivot point 201 into the touchpad depression area 114 of the touchpad housing 113. Upon deformation, the switch contact point 202 of the touchpad 104 assembly contacts the switch 111 if an input applies pressure with sufficient force. Those skilled in the art would appreciate that the pivot point 201 may be provided in any number of locations relative to the parts comprising the touchpad 104.

Referring now to FIG. 3 in combination with FIG. 1. FIG. 3 is a top-down view of an electronic input detection device of an input device, according to one embodiment. The movement input area 101 and the button area (102 and 103 combined of FIG. 1) of the touchpad may detect input through a single electronic input detection device or multiple electronic input detection devices. The electrical input detection devices comprising the touchpad 104 may be circuit boards configured to detect the capacitance of an input. FIG. 4 illustrates an embodiment where the touchpad circuit board 108 is a single circuit board comprising a movement input capacitance area 301 (corresponding to the movement input area 101 of FIG. 1), a left button capacitance area 303 (corresponding to the left button area 103 of FIG. 1), and a right button capacitance area 302 (corresponding to the right button area 102 of FIG. 1). In other embodiments, a touchpad circuit board is comprised of a movement circuit board comprising solely a movement input capacitance area, and a button circuit board comprising the left and right button capacitance areas or a single button area. In yet another embodiment, a touchpad circuit board is comprised of a movement circuit board comprising solely a movement input capacitance area, a left button circuit board comprising solely a left button capacitance area, and a right button circuit board comprising solely a right button capacitance area. The disclosed customization of movement input areas 101, button areas (102 and 103 combined of FIG. 1), and touch sensitive input areas is accomplished by designating a desired input corresponding to a region of an electrical detection input device. The customization of these input areas is discussed in more detail below. Additionally, electrical input detection devices comprising the touchpad 104 may be circuit boards configured to detect conductance, magnetism, and optical input to name but a few of the embodiments.

Referring back to FIG. 1. The input device 105 has a switch 111 located below the touchpad 104. As discussed above, the depression of the switch 111 and the detection of an input in the button area (102 and 103 combined) in combination indicates a button of the touchpad 104 was intended to be depressed. The input device 105 is further configured with a haptic response component (109, 111, 104). The haptic response component (109, 111, 104) generates a haptic response in response to application of pressure to the button area from an input. In some embodiments the switch 111 may be spring-loaded. In other embodiments, the switch may not be spring-loaded. In those embodiments with a spring-loaded switch 111, the switch 111 applies pressure back against an input during the input's application of pressure. Accordingly, in those embodiments where the switch 111 is spring-loaded, the switch 111 may be the haptic response component 111. In such an embodiment, the switch 111 applies pressure to the touchpad 104 assembly when an input applies pressure and the assembly deforms about the pivot point 201 (of FIG. 2B) into the touchpad depression area 114 of the touchpad housing 113. The switch's 111 application of pressure against the touchpad 104 generates a haptic response in response to the application of pressure from the input. In this way, the input device provides the feeling of pressing a button to the input through haptic feedback.

In other embodiments, the haptic response component is a spring finger or a plurality of spring fingers. The illustrated embodiment of FIG. 1 has a plurality of spring fingers 109. The spring fingers 109 apply pressure to the touchpad 104 assembly when an input applies pressure and the assembly deforms about the pivot point 201 (of FIG. 2B) into the touchpad depression area 114 of the touchpad housing 113. The spring fingers' application of pressure against the touchpad 104 generates a haptic response in response to the application of pressure from the input. In this way, the input device provides the feeling of pressing a button to the input through haptic feedback. Those skilled in the art appreciate that the spring fingers 109 of the illustrated embodiment may be provided in any number of locations or not provided at all. Those skilled in the art will also appreciate that embodiments of the disclosed input device 105 may be comprised of many switches located in any number of locations relative to the touchpad 104 assembly.

In some embodiments, a spring finger or plurality of spring fingers 109 in combination with a switch 111 are the haptic response component, and may generate a haptic response in response to the application of pressure from the input. In further embodiments, the touchpad 104 assembly may be the haptic response component, and the tendency of the touchpad 104 assembly to return to its original position generates haptic feedback. In yet other embodiments, the touchpad 104 assembly in combination with a switch 111 may be the haptic response component. Further, in another embodiment, the touchpad 104 assembly in combination with a spring finger or a plurality of spring fingers 109 may be the haptic response component. In yet other embodiments, the touchpad 104 and a switch 111 in combination with a spring finger or a plurality of spring fingers 109 may be the haptic response component.

Referring now to FIG. 5. FIG. 5 is a diagram of an input device 105 connected to an input receiving device 501, according to one embodiment. The input device 105 is designed to be connected through a communication channel 502 to an input receiving device 501, such that the input device 105 supplies input communications comprised of specific input messages to the input receiving device 501. In some embodiments, the communication channel 502 may be simplex or duplex. The communications channel 502 may be a directly wired electrical connection or the communication channel 502 may be wireless. By way of example, FIG. 7 illustrates an embodiment of a notebook computer including an input device 105 attached to the chassis 702, a screen 701 attached to the chassis 702, and a keyboard 703 attached to the chassis 702. Further, FIG. 8 illustrates another embodiment of a keyed input device including an input device 105 attached to a keyed input housing 801, and a keyboard 802 attached to the keyed input housing 801. In yet other embodiments, the input device 105 may be connected to a communication device such as a personal digital assistant, cellular telephone, or a wireless e-mail device.

As an example application, the input device 105 may be connected to a notebook computer (input receiving device 501 of FIG. 5). The notebook computer may be configured with a window-based operating system as is well known in the art. As is well known in the art, a user interacts with a window-based operating system through a keyed input device as well as a movement device such as a touchpad or a computer mouse. The input device 105 may provide the movement device to interact with the window-based operating system. The input device 105 provides the ability to move a cursor in the window-based operating system environment by detecting movement of an input from a user across the touchpad 104 by detecting the presence of the input in either of the movement input area 101 or the button area (102 and 103 combined). Additionally, the input device 105 allows a user to provide button input by detecting the presence of an input from the user in the button area (102 and 103 combined) in combination with the depression of a switch 111 located under the touchpad 104.

An additional feature of some embodiments of the disclosed input device 105 is the ability to provide graduated button input. In such embodiments, the switch 111 is configured to detect thresholds of pressure applied by an input to the button area (102 and 103 combined). The detection of thresholds of pressure applied is accomplished by determining how far down the switch 111 is depressed. In an example embodiment, the input device 105 could be used to provide for more precise interaction with multimedia components of a communication device (input receiving device 501 of FIG. 5) to which an input device 105 is attached. For instance, graduated button input could provide variable fast-forward or reverse for a multimedia component. Alternatively, such graduated button input may be used in a variety of different application components, such as medical testing components as well as video games.

A further additional feature in some embodiments of the disclosed input device 105 is customization of the movement input area 101 and the button area (102 and 103 combined) of the touchpad 104. In such embodiments, a user can designate which regions of the touchpad 104 correspond to the movement input area 101 and the button area (102 and 103 combined). Further, in those embodiments with a left button area 103 and right button area 102, a user may specify which regions correspond to the left button area 103 and the right button area 102. In yet further embodiments, the user may specify any number of button areas by specifying which regions correspond to those button areas. By way of example, a user in such an embodiment could specify a first, second, third, and fourth button area. The user may then specify a desired input message to be communicated to an input receiving device 501 (of FIG. 5) to which the input device 105 is connected when an input is supplied to a defined button area.

User designation may be accomplished in a variety of different ways. In one embodiment, a user may designate regions of the touchpad 104 in a user configuration component of a notebook computer (input receiving device 501 of FIG. 5) to which the input device 105 is attached. The designation of regions comprises identifying a bounded region that encompasses an area of the touchpad 104. The bounded region is expressed in terms of coordinates within the touchpad 104. For example, the designation of a movement input area 101 and a button area (102 and 103 combined) for a touchpad 104 of the dimensions 5 centimeters by 5 centimeters square with the x and y axes intersecting and equaling 0 at the bottom left corner of the touchpad 104 could be: movement input area 101 is the area bounded by the region defined by the coordinates (x=0, 5=>y>=3) and (x=5, 5=>y>=3); the button area (102 and 103 combined) is the area bounded by the region defined by the coordinates (x=0, y<=3) and (x=5, y<=3). The bounded area is not required to be composed of four sides.

The user designations may be stored as data in the hardware of the notebook computer. In such an embodiment, detection of an input in a region of the touchpad 104 may be accomplished by the input device 105 sending a communication to the notebook computer indicating that a user input is present in the bottom left corner of the touchpad 104, e.g. coordinates (x=1, y=1). Accordingly, the notebook computer may access the stored user designations to determine that the communication indicates that the input is located in the button area (102 and 103 combined) of the touchpad 104.

In an alternative embodiment, the data representing the user designations may be stored in hardware of the input device 105. In such an embodiment, the determination of where an input is present may be performed by the input device 105, and a communication indicating the region in which the input is located is communicated to the notebook computer. Alternatively, the input device 105 may transmit the data of the user designations of the regions of the touchpad 104 and the location of the input detected to the notebook computer, and the notebook computer may determine the location of the input based on the communications.

Another further feature of some embodiments of the disclosed input device 105 is a touch sensitive input area of the touchpad 104. The touch sensitive input area may be located within the movement input area 101 or the button area (102 and 103 combined). The touch sensitive input area may be configured to turn the input device 105 on or off upon the detection of the presence of an input. In other embodiments, the touch sensitive input area may be configured to turn a wireless radio on or off upon the detection of the presence of an input in the touch sensitive area. In some embodiments, the touch sensitive input area is customizable to provide customized input to the input receiving device 501 (of FIG. 5) to which the input device 105 is attached. By way of example, the touch sensitive input area may be customized to mute or turn on a sound device of an input receiving device 501 (of FIG. 5) upon the application of an input by a user.

In further embodiments, the touch sensitive input area is customizable to provide multiple touch sensitive input regions within the touch sensitive input area each with their own customizable input to be provided to an input receiving device 501 (of FIG. 5). Similar to the disclosed features of movement input area 101 and button area (102 and 103 combined) customization, touch sensitive input area customization may be accomplished in a variety of different ways. Additionally, the region corresponding to the touch sensitive input area may be visually indicated as disclosed in the discussion of FIG. 1 above.

Continuing to refer to FIG. 1. The illustrated embodiment of FIG. 1 includes a controller integrated circuit 110. The controller integrated circuit 110 may be configured to coordinate input detection by collecting signals from the touchpad circuit board 108 and the switch 111. Additionally, the controller integrated circuit 110 may be configured to send communications to an input receiving device 501 (of FIG. 5) to which the input device 105 is attached. Further, in some embodiments, the controller integrated circuit device 110 may control the illumination of the cosmetic cover 106 as disclosed above. The controller integrated circuit 110 may also store data representing customization of input areas as previously discussed. In such an embodiment, the controller integrated circuit 110 may also combine the data representing customization of input areas with signals received from the touchpad 104 to determine the input desired by a user. In other embodiments, the controller integrated circuit 110 communicates the data representing the customization of input areas in combination with signals received from the touchpad 104 to an input receiving device 501 (of FIG. 5) to which the input device 105 is connected, and the input receiving device 501 (of FIG. 5) determines the desired input. However, in some embodiments, the input device 105 may not have the device or devices that coordinate input detection or send communications to an input receiving device 501.

Referring now to FIG. 6. FIG. 6 is a flowchart detailing a method of detecting an input, according to one embodiment. In step 601, the presence of an input at a location in the button area of a touchpad 104 is detected. In step 602, an input pressing down on the button area of the touchpad is detected. In step 603, a haptic response is generated and provided directly or indirectly to the person applying the input by means of a haptic response component.

In one embodiment, the disclosed input device provides an aesthetically pleasing all-in-one design while maintaining the ability to provide a haptic response to a user. Additionally, some embodiments of the disclosed input device provide a maximized area over which movement of an input may be detected by detecting movement of an input in both the movement input area as well as the button area. The disclosed input device in some embodiments may also provide graduated button input. Features of some other embodiments include customization of the input areas of the input device, and visual indication of the regions comprising input areas.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

What is claimed is:

1. An input device, comprising:
a touchpad housing comprised of a touchpad depression area;
a touchpad attached to the touchpad housing, comprised of a movement input area, and a button area, wherein the touchpad is configured to detect a presence of an input at a location on the touchpad;
a switch located below the button area of the touchpad; and
a haptic response component for generating a haptic response in response to application of a pressure from the input to the button area.

2. The input device of claim 1, wherein the switch and the haptic response component are the same.

3. The input device of claim 1, wherein the haptic response component is a spring finger.

4. The input device of claim 1, wherein the touchpad and the haptic response component are the same.

5. The input device of claim 1, wherein regions of the touchpad comprising the movement input area and the button area are customizable.

6. The input device of claim 1, wherein the button area is comprised of a left button area and a right button area.

7. A computer notebook, comprising:
a chassis;
a screen attached to the chassis;
a keyboard attached to the chassis;
a touchpad housing comprised of a touchpad depression area;
a touchpad attached to the touchpad housing, comprised of a movement input area, and a button area, wherein the touchpad is configured to detect a presence of an input at a location on the touchpad;
a switch located below the button area of the touchpad; and
a haptic response component for generating a haptic response in response to application of a pressure from the input to the button area.

8. A keyed input device, comprising:
a keyed input housing;
a keyboard attached to the keyed input housing; and
a touchpad housing attached to the keyed input housing comprised of a touchpad depression area;
a touchpad attached to the touchpad housing, comprised of a movement input area, and a button area, wherein the touchpad is configured to detect a presence of an input at a location on the touchpad;
a switch located below the button area of the touchpad; and
a haptic response component for generating a haptic response in response to application of a pressure from the input to the button area.

9. A method of detecting input through a touchpad, comprising the steps of:
detecting a presence of an input;
detecting a pressure of the input; and
generating a haptic response to the pressure.

10. An input device comprising:
means for detecting a presence of an input;
means for detecting a pressure of the input; and
means for generating a haptic response to the pressure.
